(19) United States
(12) Patent Application Publication
(10) Pub. No.: US 2013/0283028 A1
(43) Pub. Date: Oct. 24, 2013

(54) ADAPTER IDENTIFICATION SYSTEM AND METHOD FOR COMPUTER

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: HUA ZOU, Wuhan (CN); CHUN-SHENG CHEN, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/862,603

(22) Filed: Apr. 15, 2013

(30) Foreign Application Priority Data
Apr. 19, 2012 (CN) 201210116043.7

(51) Int. Cl. G06F 9/44

(52) U.S. Cl. CPC G06F 9/441
USPC 713/2

(57) ABSTRACT

An adapter identification system for a computer includes an embedded controller (EC) configured to simulate a 1-Wire protocol controller, an adapter including a control unit and a storage unit, and a basic input output system (BIOS) chip. The adapter is assigned a first identity (ID), which is stored in the storage unit, and the control unit is used to obtain the first ID. The BIOS chip is configured to obtain the first ID through the EC, and determine whether the first ID matches one of a number of second IDs stored in the BIOS chip. The BIOS chip boots the operation system of the computer in response to the first ID matching one of the second IDs, and the BIOS chip outputs a rejection notice to a display of the computer in response to the first ID not matching one of the second IDs.

### BACKGROUND

1. Technical Field

The present disclosure relates to an adapter identification system and an adapter identification method for a computer.

2. Description of Related Art

A portable computer, such as a notebook computer, may acquire power from an adapter converting alternating current (AC) power to direct current (DC) power. Often, different portable computers, particularly different brands of computers, can only be used with adapters designed for the particularly type of computer in use and no other. If somehow the wrong adaptor were connected to a computer, the computer could be damaged.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an adapter identification system for a computer of the present disclosure.

FIG. 2 is a flow chart of an embodiment of an adapter identification method for a computer of the present disclosure.

### DETAILED DESCRIPTION

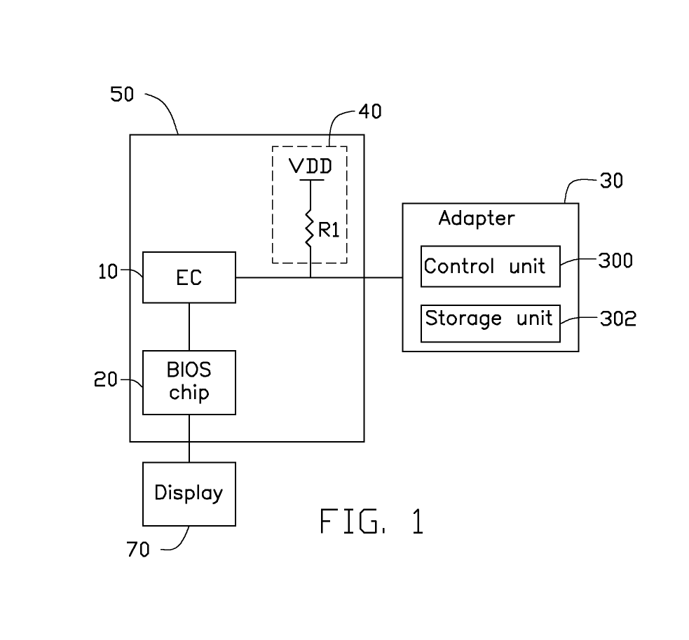

FIG. 1 shows an embodiment of an adapter identification system of the present disclosure. The adapter identification system includes an embedded controller (EC) 10, a basic input output system (BIOS) chip 20 coupled to the EC 10, a pull-up circuit 40, and an adapter 30. In the embodiment, the EC 10, the BIOS chip 20, and the pull-up circuit 40 are arranged in a computer 50, such as a notebook computer. The adapter 30 is assigned with a first identity (ID). When outside power is needed for the computer 50, the EC 10 is coupled to the adapter 30 through a 1-Wire bus.

The BIOS chip 20 stores a plurality of second IDs corresponding to the adapters matching the computer. The BIOS chip 20 obtains the first ID from the adapter 30 through the EC 10, and a determination is made by the BIOS chip 20 whether the first ID matches one of the second IDs. In the embodiment, the EC 10 is configured to simulate a 1-Wire protocol controller, and communicates with the adapter 30 through a general purpose input output (GPIO) pin.

The adapter 30 includes a control unit 300 and a storage unit 302. The storage unit 302 is a read only memory (ROM), in which the first ID of the adapter 30 is stored. The control unit 300 is configured to respond to requests from the EC 10. For example, the control unit 300 of the adapter 30 transmits the first ID to the EC 10 in response to receiving an ID request from the EC 10.

In the embodiment, the pull-up circuit 40 includes a resistor R1. The adapter 30 is coupled to a power terminal VDD through the resistor R1. The pull-up circuit 40 is configured to pull up a high level voltage signal, such as logical 1, during the communication between the EC 10 and the adapter 30, thereby improving the communication quality.

According to the 1-Wire protocol, when a master device (e.g., the EC 10 in the embodiment) communicates with a slave device (e.g., the adapter 30 in the embodiment), the master device needs to output a low level reset signal to the slave device 30, and the duration of the low level reset signal should not be less than 480 nanoseconds (ns). The slave device 30 needs to output a high level present signal to the master device 10 in response to receiving the low level reset signal, and the duration of the present signal is between 60 ns and 240 ns. The master device 10 then can output commands to the slave device 30 to control the slave device 30.

In use, the adapter 30 is plugged into the computer 50, and the computer 50 is powered on. The BIOS chip 20 then obtains the first ID of the adapter 30 through the EC 10. For example, the EC 10 outputs the low level reset signal for not less than 480 ns to the control unit 300 of the adapter 30. Accordingly, the control unit 300 outputs the high level present signal for 60 ns to 240 ns to the EC 10. The EC 10 determines that the adapter 30 is coupled to the computer 50, and outputs an ID request to obtain the first ID of the adapter 30. The control unit 300 obtains the first ID from the storage unit 302 in response to receiving the ID request, and transmits the first ID to the EC through the 1-Wire bus. After that, the EC 10 transmits the first ID to the BIOS chip 20. The BIOS chip 20 compares the first ID with the plurality of second IDs, and determines whether the first ID matches one of the second IDs or not. The BIOS chip 20 boots the operation system of the computer 50 in response to the first ID matching one of the second IDs. Otherwise, the BIOS chip 20 outputs a rejection notice to a display 70 of the computer 50, and shuts down the computer 50 after a predetermined time, such as 5 seconds, to avoid damage to the computer 50 from being powered through an unsuitable adapter 30.

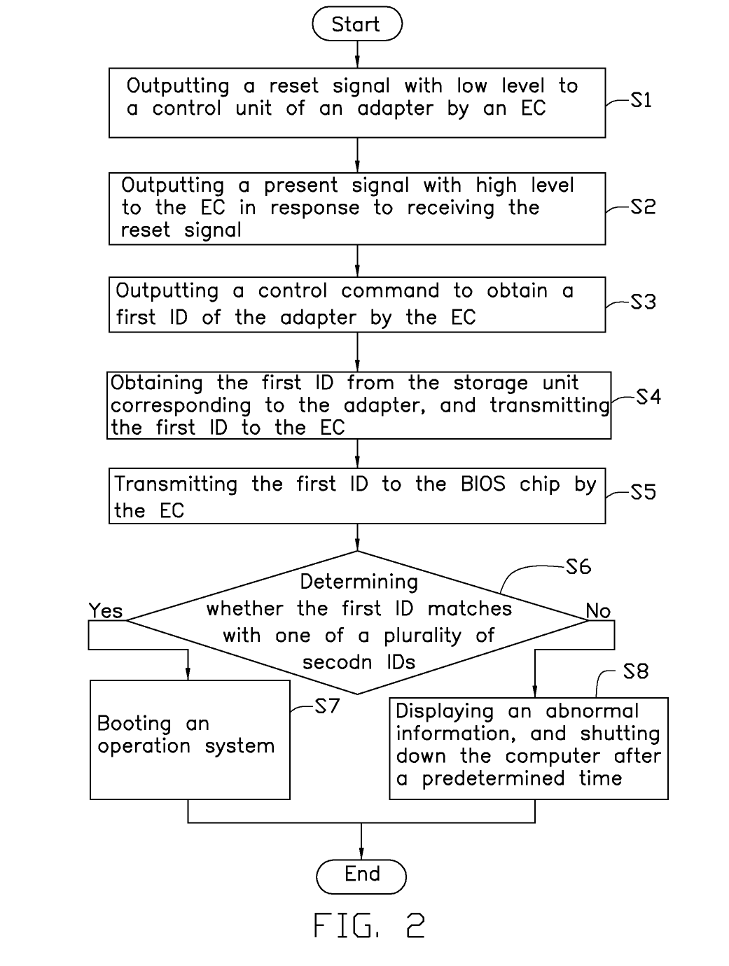

FIG. 2 shows an adapter identification method for a computer 50 of the present disclosure. The method includes steps shown below.

In step S1, the EC 10 outputs a low level reset signal to the control unit 300 of the adapter 30 for not less than 480 ns.

In step S2, the control unit 300 outputs a high level present signal to the EC 10 in response to receiving the reset signal, where the duration of the present signal is between 60 ns and 240 ns.

In step S3, the EC 10 outputs an ID request to the control unit 300 of the adapter 30 to obtain the first ID of the adapter 30.

In step S4, the control unit 300 obtains the first ID from the storage unit 302, and transmits the first ID to the EC 10.

In step S5, the EC 10 transmits the first ID to the BIOS chip 20.

In step S6, the BIOS chip 20 compares the first ID with a plurality of second IDs, to determine whether the first ID matches one of the second IDs. If the first ID matches one of the second IDs, step S7 is implemented. If the first ID does not match any one of the second IDs, step S8 is implemented.

In step S7, the BIOS chip 20 boots the operation system of the computer 50.

In stem S8, the BIOS chip 20 outputs a rejection notice on the display 70 of the computer 50, and shuts down the computer 50 after a predetermined time.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An adapter identification system for a computer, comprising:
an embedded controller (EC), configured to simulate a 1-Wire protocol controller;
an adapter comprising a control unit and a storage unit, wherein the adapter communicates with the EC through a 1-Wire bus, the adapter is assigned with a first identity (ID) stored in the storage unit, the control unit is used to obtain the first ID; and
a basic input output system (BIOS) chip, configured to obtain the first ID through the EC, and determine whether the first ID matches one of a plurality of second IDs stored in the BIOS chip;
wherein the BIOS chip boots an operation system of the computer in response to the first ID matching one of the plurality of second IDs, the BIOS chip outputs a rejection notice to a display of the computer in response to the first ID not matching one of the plurality of second IDs.

2. The adapter identification system of claim 1, wherein the BIOS chip also shuts down the computer after a predetermined time, in response to the first ID not matching one of the plurality of second IDs.

3. The adapter identification system of claim 2, further comprising a pull-up circuit, wherein the pull-up circuit comprises a resistor, the adapter is coupled to a power terminal through the resistor.

4. The adapter identification system of claim 1, wherein the EC outputs a reset signal to the adapter when the BIOS chip obtains the first ID of the adapter, the control unit of the adapter outputs a present signal in response to receiving the reset signal, the EC outputs an ID request to the adapter in response to receiving the present signal, the control unit obtains the first ID from the storage unit, and transmits the first ID to the EC, the EC transmits the first ID to the BIOS chip.

5. The adapter identification system of claim 4, wherein the reset signal is a low level signal with a duration not less than 480 nanoseconds (ns), the present signal is a high level signal with a duration between 60 ns and 240 ns.

6. An adapter identification method for a computer, comprising:
outputting a reset signal to a control unit of an adapter by an embedded controller (EC);
outputting a present signal to the EC in response to receiving the reset signal by the control unit;
transmitting an identity (ID) request to the control unit to obtain a first ID of the adapter by the EC;
obtaining the first ID from a storage unit of the adapter and transmitting the first ID to the EC by the control unit;
transmitting the first ID to a basic input output system (BIOS) chip;
determining whether the first ID matches one of a plurality of second IDs stored in the BIOS chip; and
booting an operation system of the computer in response to the first ID matching one of the plurality of second IDs.

7. The adapter identification method of claim 6, further comprising:
outputting a rejection notice to a display of the computer in response to the first ID not matching one of the plurality of second IDs.

8. The adapter identification method of claim 7, further comprising:
shutting down the computer after a predetermined time in response to the first ID not matching one of the plurality of second IDs.

9. The adapter identification method of claim 8, wherein the reset signal is a low level signal with a duration not less than 480 nanoseconds (ns).

10. The adapter method of claim 9, wherein the present signal is a high level signal with a duration between 60 ns and 240 ns.
